(19) United States
(12) Patent Application Publication
(10) Pub. No.: US 2016/0324076 A1
(43) Pub. Date: Nov. 10, 2016

(54) HORTICULTURAL STRUT FOR FACILITATING PLANT GROWTH AND PRODUCTION METHOD THEREFOR

(71) Applicant: JIANGSU HENYUAN GARDEN SUPPLIES CO., LTD, Changzhou, Jiangsu (CN)

(72) Inventor: Shuiping YANG, Changzhou, Jiangsu (CN)

(73) Assignee: JIANGSU HENYUAN GARDEN SUPPLIES CO., LTD, Changzhou, Jiangsu (CN)

(21) Appl. No.: 15/109,693

(22) PCT Filed: Jan. 6, 2015
(86) PCT No.: PCT/CN2015/000006

§ 371 Date: Jul. 5, 2016

(30) Foreign Application Priority Data
Jan. 10, 2014 (CN) 201410011456.8

(51) Int. Cl. A01G 9/12

(52) U.S. Cl. CPC A01G 9/122

(57) ABSTRACT

Disclosed is a horticultural strut for facilitating plant growth, comprising a metal tube (1) and a plastic layer (2) covering the surface of the metal tube (1), wherein there is at least one auxiliary spirally disposed rib strip (21) along the metal tube in the axial direction at the surface of the plastic layer (2), and rod sleeves are provided at both ends of the metal tube (1), respectively. The addition of auxiliary spirally disposed rib strips on the coated plastic tube makes vines and climbing plants climb up along the spiral auxiliary rib strips, improves the adhesive force of the vines and climbing plants, and facilitate the growth of vines and climbing plants.

This application is the U.S. national phase of International Application No. PCT/CN2015/000006 Filed on 6 Jan. 2015 which designated the U.S. and claims priority to Chinese Application Nos. CN201410011456.8 filed on Jan. 1, 2014, the entire contents of each of which are hereby incorporated by reference.

### TECHNICAL FIELD

The present invention relates to the technical field of support rods, and in particular to a horticultural strut for facilitating plant growth and a production method therefor.

### BACKGROUND ART

In the field of agricultural production, peasants generally use wooden rods or bamboo rods to erect frames for facilitating growth of vines and climbing plants, such as dishcloth gourd, hyacinth beans and tomatoes; although these wooden rods or bamboo rods are environmentally friendly, the rods are aged or break after being exposed to the weather. Therefore, on one hand, the rods are not beneficial to plant growth, and on the other hand, the rods are disposable, and a large amount of wooden rods and bamboo rods are wasted. Further, flower stands are also needed to assist flower shape fixation in the field of ornamental flowers.

Therefore, a horticultural strut specially designed for agricultural production and flower planting is disclosed. The horticultural strut comprises a metal tube and a plastic layer covering the metal tube, plastic sealing heads are installed at both ends of the metal tube respectively, wherein one plastic sealing head is spiny for facilitating insertion into soil, and the other plastic sealing head is planar. The metal tube is a common straight tube or bent tube. A hammer is needed to beat the planar plastic sealing head when the horticultural strut is inserted in the soil during operation, the plastic sealing head may be damaged to expose the metal rod to the air if overexertion occurs at the moment, the metal rod may be oxidized over time, and the service life is influenced.

Vines and climbing plants climb and attach to the horticultural strut in the growth process, while the plastic layer is generally smooth, so that the adhesive force of the plants are not enough and the growth of the plants is influenced. There are also a mode of conducting grinding treatment on the surface of the plastic layer and a mode of forming hard spots on the surface of the plastic layer, but the two modes are poor in effect.

### SUMMARY OF THE INVENTION

The present invention aims at solving the technical problem that horticultural struts in the prior art are not beneficial to the growth of vines and climbing plants and providing a horticultural strut for facilitating plant growth, which can make vines and climbing plants grow up along spirally arranged auxiliary rib strips.

The technical solution for solving the technical problem of the present invention is that a horticultural strut for facilitating plant growth is provided; the horticultural strut for facilitating plant growth comprises a metal tube and a plastic layer covering the surface of the metal tube, there is at least one auxiliary spirally disposed rib strip 21 along the metal tube in the axial direction at the surface of the plastic layer, and rod sleeves are provided at both ends of the metal tube, respectively. The spirally arranged auxiliary rib strips more conform to the growth tendency of vines and climbing plants.

Further, the number of the auxiliary rib strips is 3 to 4. The number of the auxiliary rib strips should not be too much, and the best number is 3 to 4.

Further, for facilitating climbing of vines and climbing plants, the auxiliary rib strips are corrugated with respect to the surface of the plastic layer. Namely, the auxiliary rib strips are in concavo-convex shapes, the adhesive force of vines and climbing plants to the auxiliary rib strips are increased to facilitate climbing of vines and climbing plants, and even though crops are exposed to wind and rain, the crops do not easily slip off.

Further, for improving the structural strength of the horticultural strut, the both ends of the metal tube are in necked shapes. After the ends are necked, the strength of the metal tube is enhanced, and the metal tube is not likely damaged when being beaten for installation.

Preferably, the necked shapes of the metal tube are shapes of circular truncated cones.

Further, the screw pitches of the spirally arranged auxiliary rib strips are 50 to 70 cm.

Preferably, the length of the metal tube is 60 cm, and the screw pitches of the spirally arranged auxiliary rib strips are 60 cm.

Preferably, the rod sleeves are sharp-end sleeves or flat-end sleeves.

The present invention has the beneficial effects that the horticultural strut for facilitating plant growth of the present invention can make vines and climbing plants climb up along the spiral auxiliary rib strips, improve the adhesive force of vines and climbing plants and facilitate the growth of vines and climbing plants by adding the spirally arranged auxiliary rib strips on the plastic coated tube. The both ends of the metal tube are necked, the strength is effectively enhanced, and damage is not likely produced during installation.

### BRIEF DESCRIPTION OF THE DRAWINGS

Further description of the present invention will be given in combination with attached drawings and embodiments below.

FIG. 1 is a structural schematic view of a preferred embodiment of a horticultural strut for facilitating plant growth of the present invention;

FIG. 2 is an exploded view of the preferred embodiment of the horticultural strut for facilitating plant growth of the present invention;

FIG. 3 is a stereo view of another embodiment of the horticultural strut for facilitating plant growth of the present utility model; and

FIG. 4 is an enlarged view of the portion A in FIG. 3.

In the FIGS: 1 metal tube, 2 plastic layer, 21 auxiliary rib strips, 3 sharp-end sleeve, and 4 flat-end sleeve.

### DETAILED DESCRIPTION OF THE INVENTION

Now further detailed description of the invention will be given in combination with attached drawings. These drawings are simplified schematic views, are only used for schematically describing the basic structure of the present invention and accordingly show the composition relevant with the present invention only.

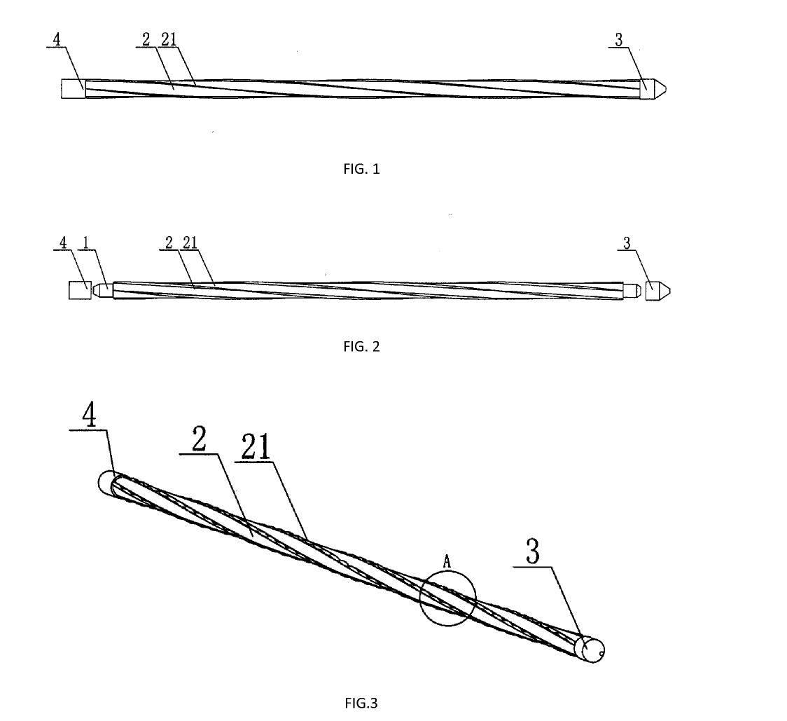

As shown in FIGS. 1 and 2, a horticultural strut for facilitating plant growth of the present invention comprises a metal tube 1 and a plastic layer 2 covering the surface of the metal tube 1, there is at least one auxiliary spirally disposed rib strip 21 along the metal tube in the axial direction at the surface of the plastic layer 2, and rod sleeves are arranged at both ends of the metal tube 1 respectively and are sharp-end sleeves 3 or flat-end sleeves 4. The spirally arranged auxiliary rib strips 21 more conform to the growth tendency of vines and climbing plants.

Further, the number of the auxiliary rib strips 21 is 3 to 4. The number of the auxiliary rib strips 21 should not be too much, and the best number is 3 to 4.

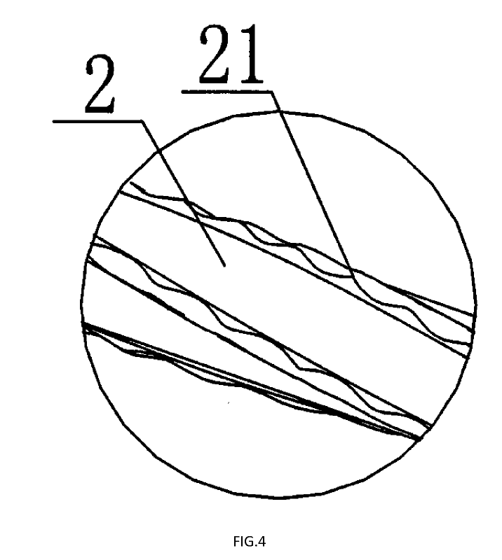

As shown in FIGS. 3 and 4, further, for facilitating climbing of vines and climbing plants, the auxiliary rib strips 21 are corrugated with respect to the surface of the plastic layer 2. Namely, the auxiliary rib strips are in concavo-convex shapes for facilitating climbing of vines and climbing plants,

Further, for improving the structural strength of the horticultural strut, the both ends of the metal tube 1 are in necked shapes. After the ends are necked, the strength of the metal tube 1 is enhanced, and the metal tube 1 is not likely damaged when being beaten for installation.

Preferably, the necked shapes of the metal tube 1 are shapes of circular truncated cones.

Further, the screw pitches of the spirally arranged auxiliary rib strips 21 are 50 to 70 cm.

Preferably, the length of the metal tube 1 is 60 cm, and the screw pitches of the spirally-arranged auxiliary rib strips 21 are 60 cm.

Multiple horticultural struts in the Figures can be connected together to form a framework, and after the framework erected by the horticultural struts is adopted, vines and climbing plants climb along column bodies, the adhesive force are increased with the help of the auxiliary rib strips, and the vines and climbing plants can well grow up to obtain more sunlight.

A method for producing the horticultural strut for facilitating plant growth comprises the following steps:

(1) preparing a metal tube, thermally compounding a plastic layer for the metal tube on a plastic coating machine and rotating the metal tube penetrating through a plastic coating die head in the plastic coating machine to form spiral auxiliary rib strips;

(2) cutting off the metal tube coated with plastic according to a required length;

(3) stripping the plastic layers at the both ends of the metal tube with a heat knife respectively to expose metal portions, and thermally compounding a plastic flat-end sleeve and a sharp-end sleeve at the exposed metal portions respectively; and

(4) performing acceptance inspection and obtaining a finished product.

Further, after the plastic layers at the both ends of the metal tube are striped, extrusion and necking processing is performed on the ends of the metal portions to enable the calibers of the ends of the metal portions to be smaller than the diameter of the body of the metal tube.

The plastic coating machine adopted by the present invention comprises a machine body, wherein a plastic coating die head is arranged on the machine body, a molten plastic material is provided for the plastic coating die head through a feeding device, the plastic coating die head is provided with a die hole for the metal tube to penetrate through, the metal tube is coated with plastic through a plastic injection hole formed in the die hole, the plastic is rapidly cooled and cured through a cooling device, and the plastic coating die head rotates in the moving process of the metal tube to form the spiral auxiliary rib strips on the surface of the plastic layer.

Based on the teaching from the ideal embodiments according to the present invention described above, related workers can completely perform various changes and modifications without departing from the technical scope and spirit of the present invention according to the contents described above. The technical scope of the present invention is not limited to the contents of the description and must be determined according to the scope of the claims.

What is claimed is:

1. A horticultural strut for facilitating plant growth, comprising a metal tube and a plastic layer covering the surface of the metal tube, and wherein there is at least one auxiliary spirally disposed rib strip along the metal tube in the axial direction at the surface of the plastic layer, and rod sleeves are provided at both ends of the metal tube respectively.

2. The horticultural strut for facilitating plant growth of claim 1, wherein the number of the auxiliary rib strips is 3 to 4.

3. The horticultural strut for facilitating plant growth of claim 1, wherein the auxiliary rib strips are corrugated with respect to the surface of the plastic layer.

4. The horticultural strut for facilitating plant growth of claim 1, wherein the both ends of the metal tube are in necked shapes.

5. The horticultural strut for facilitating plant growth of claim 4, wherein the necked shapes of the metal tube are shapes of circular truncated cones.

6. The horticultural strut for facilitating plant growth of claim 1, wherein the screw pitches of the spirally arranged auxiliary rib strips are 50 to 200 cm.

7. The horticultural strut for facilitating plant growth of claim 1, wherein the length of the metal tube is 150 cm, and the screw pitches of the spirally arranged auxiliary rib strips are 60 to 100 cm.

8. The horticultural strut for facilitating plant growth of claim 1, wherein the rod sleeves are sharp-end sleeves or flat-end sleeves.

9. A method for producing the horticultural strut for facilitating plant growth, comprising the following steps:
(1) preparing a metal tube, thermally compounding a plastic layer for the metal tube on a plastic coating machine and rotating the metal tube penetrating through a plastic coating die head in the plastic coating machine to form spiral auxiliary rib strips;
(2) cutting off the metal tube coated with plastic according to a required length;
(3) stripping the plastic layers at the both ends of the metal tube with a heat knife respectively to expose metal portions, and thermally compounding a plastic flat-end sleeve and a sharp-end sleeve at the exposed metal portions respectively; and
(4) performing acceptance inspection and obtaining a finished product.

10. The method for producing the horticultural strut of claim 9, wherein after the plastic layers at the both ends of the metal tube are striped, extrusion and necking processing is performed on the ends of the metal portions to enable the calibers of the ends of the metal portions to be smaller than the diameter of the body of the metal tube.
